(19) United States
(12) Patent Application Publication
(10) Pub. No.: US 2008/0238905 A1
(43) Pub. Date: Oct. 2, 2008

(54) Driver circuit of display unit separating amplifier and output terminal in response to test signal and method of controlling the same

(75) Inventor: Tadayoshi Matsui, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/071,763

(22) Filed: Feb. 26, 2008

(30) Foreign Application Priority Data
Mar. 28, 2007 (JP) 2007-083800

(51) Int. Cl. G06F 3/038

(52) U.S. Cl. 345/205

(57) ABSTRACT

A drive circuit of a display unit includes an output circuit. The output circuit has an amplifier which amplifies an analog signal voltage according to a digital image signal, and a switch which turns off to isolate an output of the amplifier from an output terminal in response to a test signal.

### BACKGROUND OF THE INVENTION

1. Field of the Invention

The present invention relates to a drive circuit of a display unit and a test method of the same, and in particular to the drive circuit of a display unit including a switch for separating an output of an amplifier in an output circuit from an output terminal and the test method thereof.

2. Description of Related Art

As shown in FIG. 4, a liquid crystal display used as a dot matrix display, as a related art, includes a liquid crystal display panel 101, a data drive circuit 102, a scanning drive circuit 103, a power circuit 104 and a control circuit 105.

The liquid crystal display panel 101 includes a data line 106 laterally arranged and vertically extended and a scanning line 107 vertically arranged and laterally extended in FIG. 4. Each individual pixel has a TFT 108, a pixel capacity 109 and a liquid crystal element 110. A gate terminal of the TFT 108 is connected to the scanning line 107, and a source (drain) terminal thereof is connected to the data line 106 respectively. The drain (source) terminal of the TFT 108 is connected to the pixel capacity 109 and the liquid crystal element 110 respectively. A terminal 111 of the pixel capacity 109 and the liquid crystal element 110 on the side not connected to the TFT 108 is connected to a common electrode not shown for instance.

The data drive circuit 102 drives the data line 106 by outputting analog signal voltage based on a digital image signal (hereafter, referred to as data). The scan drive circuit 103 drives the scanning line 107 by outputting selective/nonselective voltage of the TFT 108. The control circuit 105 controls timing of driving by the scan drive circuit 103 and the data drive circuit 102. The power circuit 104 supplies power supply voltage to the data drive circuit 102 for outputting the analog signal voltage and the scan drive circuit 103 for outputting the selective/nonselective voltage. As will be described below, the present invention is related to the data drive circuit 102.

In many cases, the data drive circuit 102 has multiple driver circuits composed of semiconductor integrated circuit devices. For instance, in the case where resolution of the liquid crystal panel is XGA (1024×768 pixels: 1 pixel includes 3 dots of R (red), G (green) and B (blue)), the data drive circuit 102 includes eight pieces with display of 128 pixels shared by one piece.

FIG. 5 is a block diagram showing a driver circuit 1 as a related art, and FIG. 6 is a timing chart of each of the signals inputted to the general driver circuit 1 shown in FIG. 5. The driver circuit 1 shares display of m pixels per piece, and so it outputs S1 to Sn signals to the data line 106 of n pieces=m×3 dots. To simplify the description, the description will be given based on the following. The driver circuit 1 receives serially data by an equivalent of one output of the S1 to Sn signals, that is, at bit width of the data equivalent to 1 dot of 1 pixel. The driver circuit 1 includes a shift register 2, a data register 3, a data latch circuit 4, a level shifter 5, a D/A converter 6 and an output circuit 7. The output of the shift register 2 is cascade-outputted to a next-stage driver circuit.

The shift register 2 has n stages of registers, where a shift start pulse and a clock are supplied. The start pulses are sequentially shifted in timing of the clock so that they become a shift pulse (SP1) to a shift pulse (SPn) shown in FIG. 6.

The data register 3 has n stages of registers, where the data is supplied to each of the registers in parallel. Each of the registers sequentially holds the data in falling edge timing, for instance, of the shift pulse (SPI) to the shift pulse (SPn) supplied by the shift register 2.

When the data are inputted to all the registers of the data register 3, the data latch circuit 4 receives a data latch signal so as to latch all the data held by each of the registers of the data register 3. The levels of the latched data are shifted by the level shifter 5.

The D/A converter 6 decodes the level-shifted data and outputs gradation voltage. The D/A converter 6 selectively outputs the gradation voltage equivalent to the data out of the gradation voltage of which number of gradation steps is 64 gradation steps for instance generated by supplying gradation reference voltage. The output circuit 7 amplifies the output of the D/A converter 6 and outputs it as output signals S1 to Sn. The data latch signal and a polarity inversion signal supplied to the data latch circuit 4 are also supplied to the output circuit 7 so as to select and output the output of a polarity according to the polarity inversion signal in timing of the data latch signal.

Next, the output circuit 7 will be described with reference to FIG. 7. The output circuit 7 includes an AMP 7a for amplifying and outputting the output according to the polarity from the D/A converter 6 and a switch 7b for controlling on and off of the output of the AMP 7a (hereafter, referred to as an off switch). As shown in FIG. 6, the off switch 7b turns off the output according to the polarity of the amplifier as an output high impedance period from a leading edge to a falling edge of the pulse of the data latch signal. This is a transition period of the D/A converter 6, where the off switch 7b can be turned off to be at high impedance (Hi-Z) until potential is determined (refer to Japanese Patent Laid-Open No. 2004-29316 for instance).

As for the driver circuit 1, fine patterning has progressed in order to curb increase in chip size in conjunction with increase in the number of outputs due to growth in size of the display panel. As there is an increasing rejection rate due to a leakage current on an output of the output circuit in a chip stage and a product stage, a test is conducted as to a leakage current fault detection. When testing the leakage current fault detection with high accuracy, the off switch 7b is turned off in order to separate the output of the AMP 7a (refer to Japanese Patent Laid-Open No. 2000-66641 for instance).

In general as for a fault detection test of the driver circuit, test data on a predetermined testing pattern is generated by an LSI tester (pattern generator) so that the test is conducted based on the test data. Regarding the above-mentioned test of the leakage current fault detection, in the case of turning off the off switch 7b with the data latch signal, as shown in FIG. 7, the testing pattern must be run until the data latch signal becomes an “H” level and stopped once in the “H” level state so as to turn off the off switch 7b. For this reason, there is a problem that test time of the leakage current fault detection becomes long.

### SUMMARY OF THE INVENTION

A drive circuit of a display unit includes an output circuit. The output circuit has an amplifier which amplifies an analog signal voltage according to a digital image signal, and a switch which turns off to isolate an output of the amplifier from an output terminal in response to a test signal.

A method of controlling a drive circuit of a display unit including an output circuit includes turning off a switch to electrically separate an amplifier from an output terminal, in response to a test signal independently of a data latch signal to detect a leakage current fault on said output of the output circuit.

The present invention can reduce the entire test time by shortening the test time of the leakage current fault detection in an operation test of the driver circuit.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a block diagram showing a driver circuit according to an embodiment of the present invention;

FIG. 2 is a diagram showing an output circuit of the driver circuit shown in FIG. 1;

FIG. 3 is a diagram showing an example of a test apparatus of the driver circuit according to the embodiment of the present invention shown in FIG. 2;

FIG. 4 is a block diagram showing a liquid crystal display of a related art;

FIG. 5 is a block diagram showing a general driver circuit of a related art;

FIG. 6 is a timing chart of each of signals inputted to the driver circuit shown in FIG. 5; and

FIG. 7 is a diagram showing the output circuit of the driver circuit shown in FIG. 5.

### DETAILED DESCRIPTION OF THE EXEMPLARY EMBODIMENTS

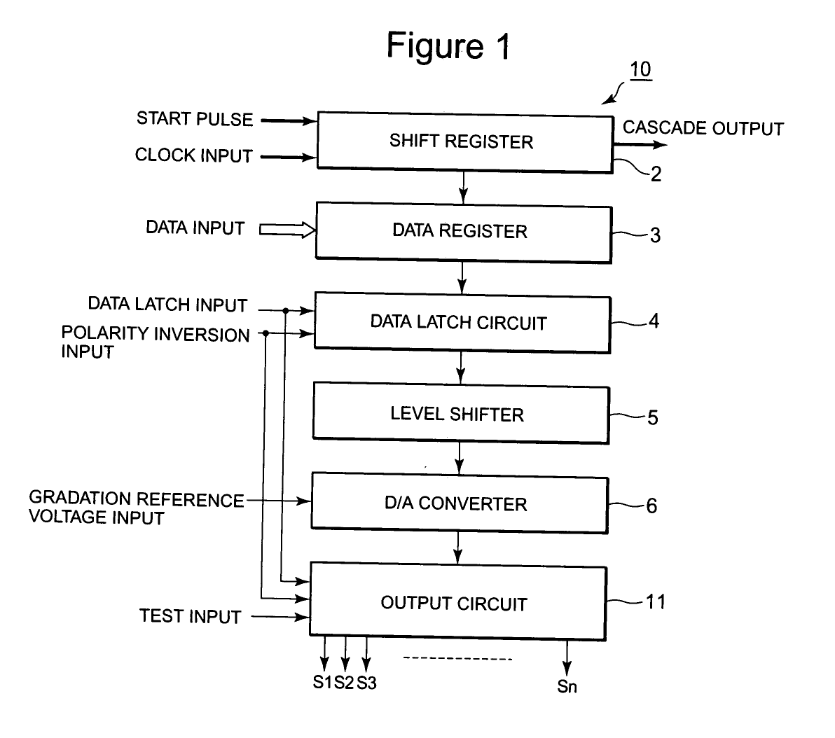

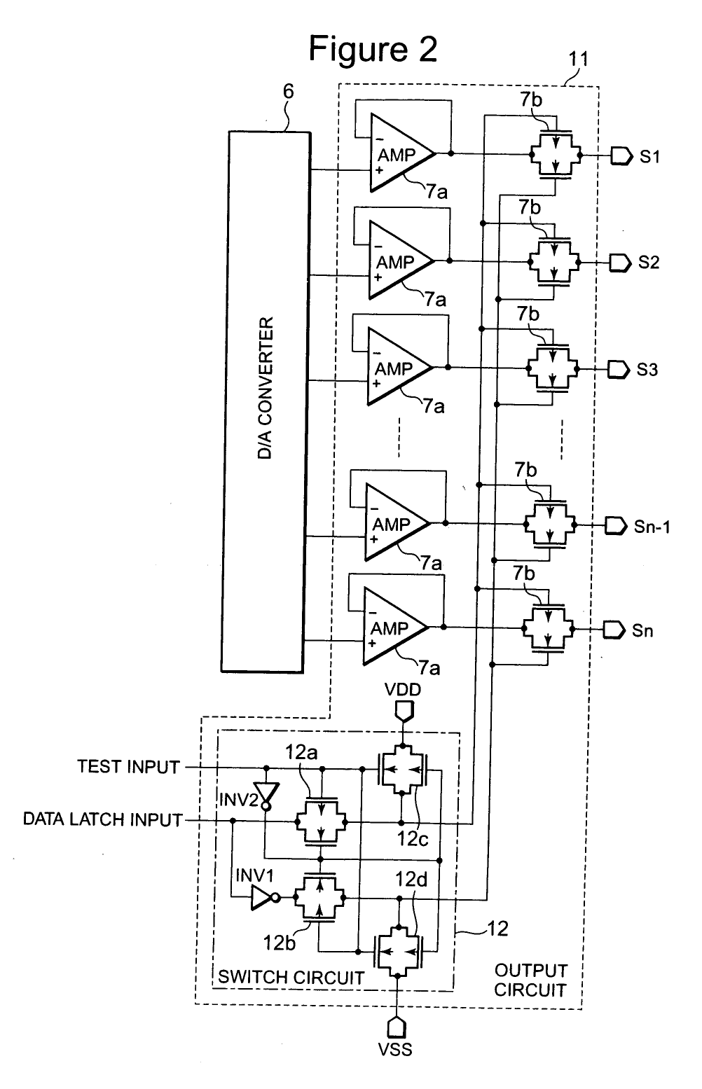

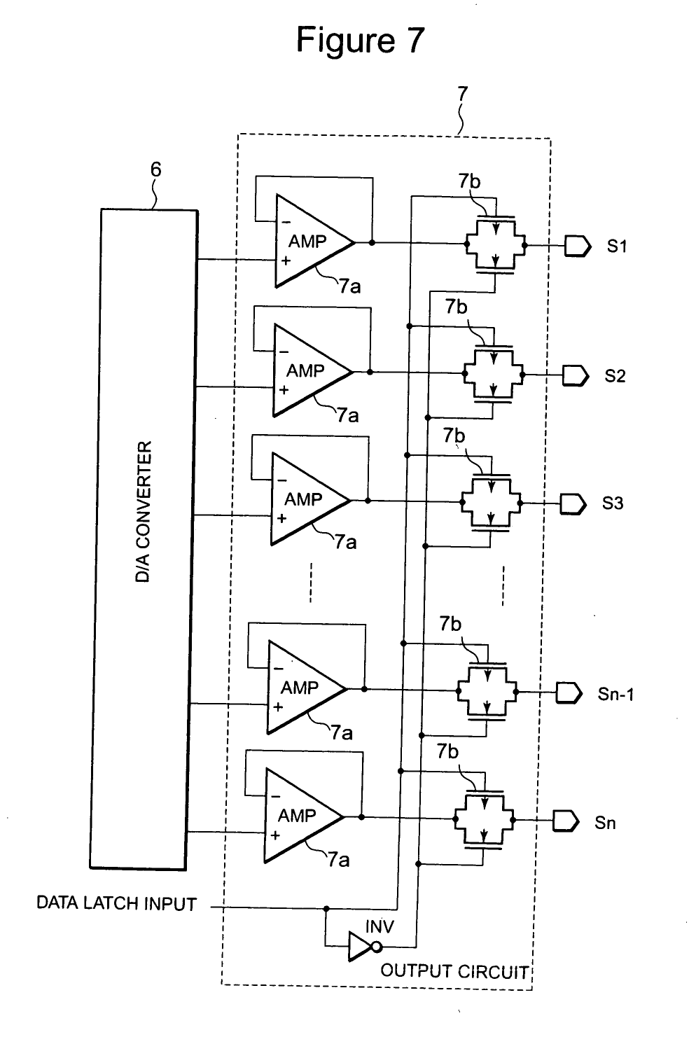

FIG. 1 is a block diagram showing a configuration of a driver circuit 10 according to an embodiment of the present invention. FIG. 2 is a diagram showing an output circuit 11 of the driver circuit 10. The same components as those in as FIGS. 5 and 7 will be given the same symbols, and a description thereof will be omitted. The driver circuit 10 is different from a driver circuit 1 in that it includes the output circuit 11 instead of an output circuit 7. The output circuit 11 is different from the output circuit 7 in that it includes a switch circuit 12.

The switch circuit 12 includes switches 12a, 12b, 12c and 12d of the same configuration as an off switch 7b. The switch 12a is connected between a data latch input and a gate of P-channel transistor of the off switch 7b. The switch 12b is connected between the data latch input via an inverter INV 1 and a gate of a N-channel transistor of the off switch 7b. The switch 12c is connected between a high power source potential terminal VDD and the gate of the P-channel transistor of the off switch 7b. The switch 12d is connected between a low power source potential terminal VSS and the gate of the N-channel transistor of the off switch 7b.

The switches 12a and 12b are on-controlled in normal operation in which no test signal is inputted and off-controlled in a test mode in which the test signal is inputted. The switches 12c and 12d are off-controlled in the normal operation in which no test signal is inputted and on-controlled in the test mode in which the test signal is inputted. Therefore, in the normal operation, a data latch signal is inputted to the gate of the P-channel of the off switch 7b via the switch 12a, and an inversion signal of the data latch signal is inputted to the gate of the N-channel of the off switch 7b via the switch 12b. Thus, the off switch 7b is off-controlled when the data latch signal is at an “H” level. In the test mode, a fixed potential of the high power source potential VDD is inputted to the gate of the P-channel of the off switch 7b via the switch 12c, and a fixed potential of the low power source potential VSS is inputted to the gate of the N-channel of the off switch 7b via the switch 12d. Thus, the off switch 7b is off-controlled.

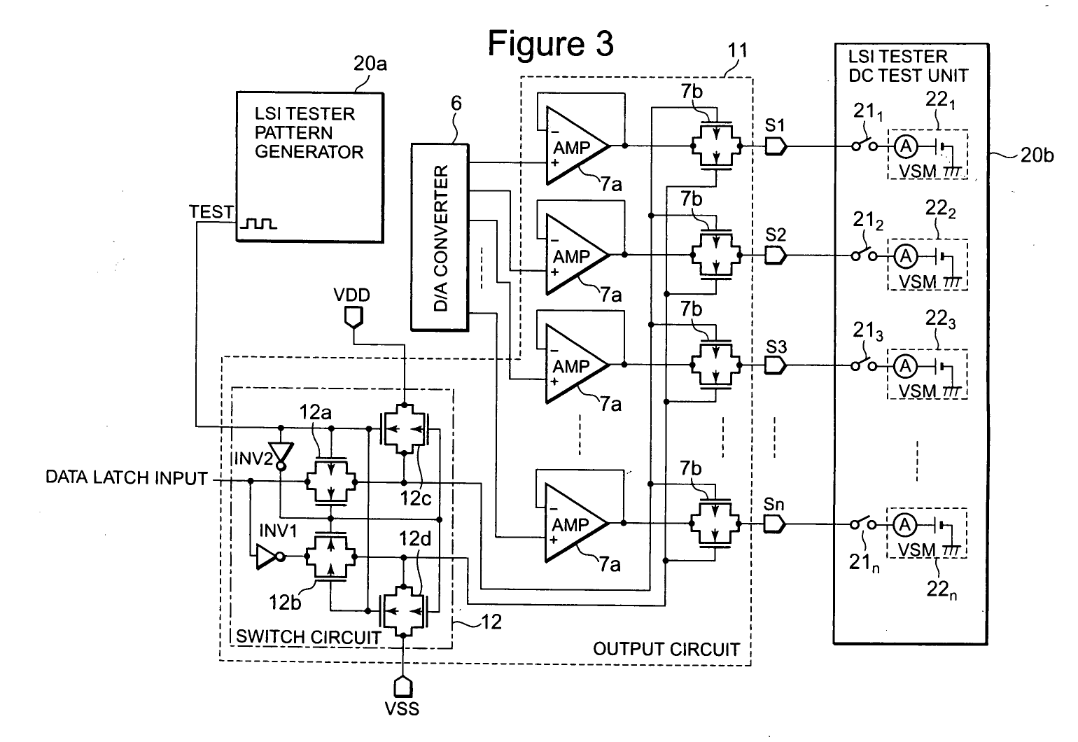

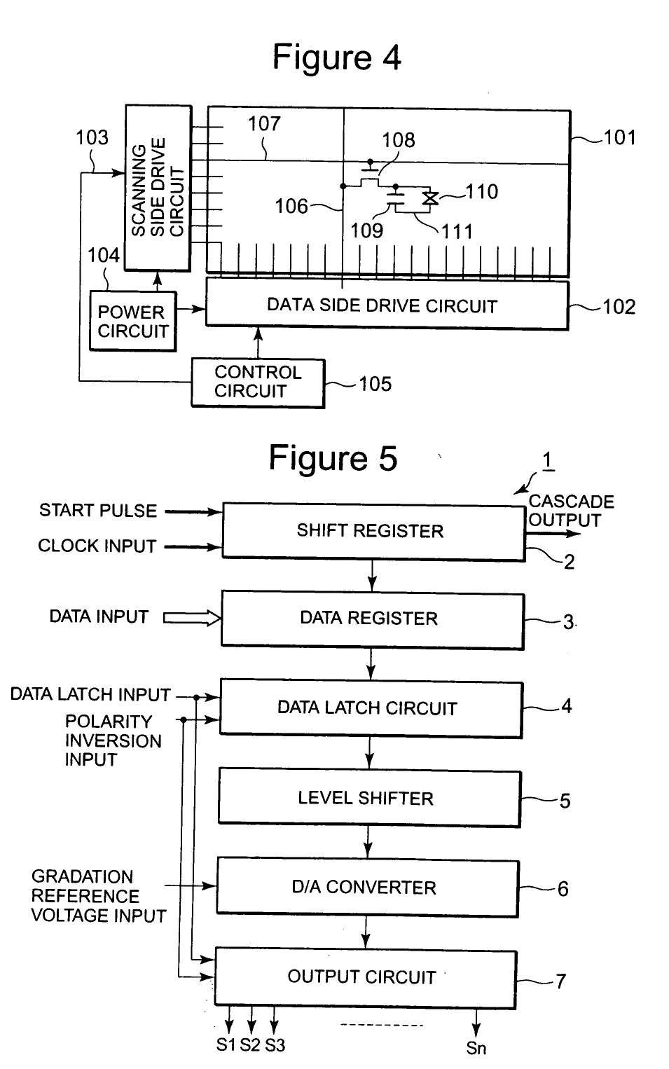

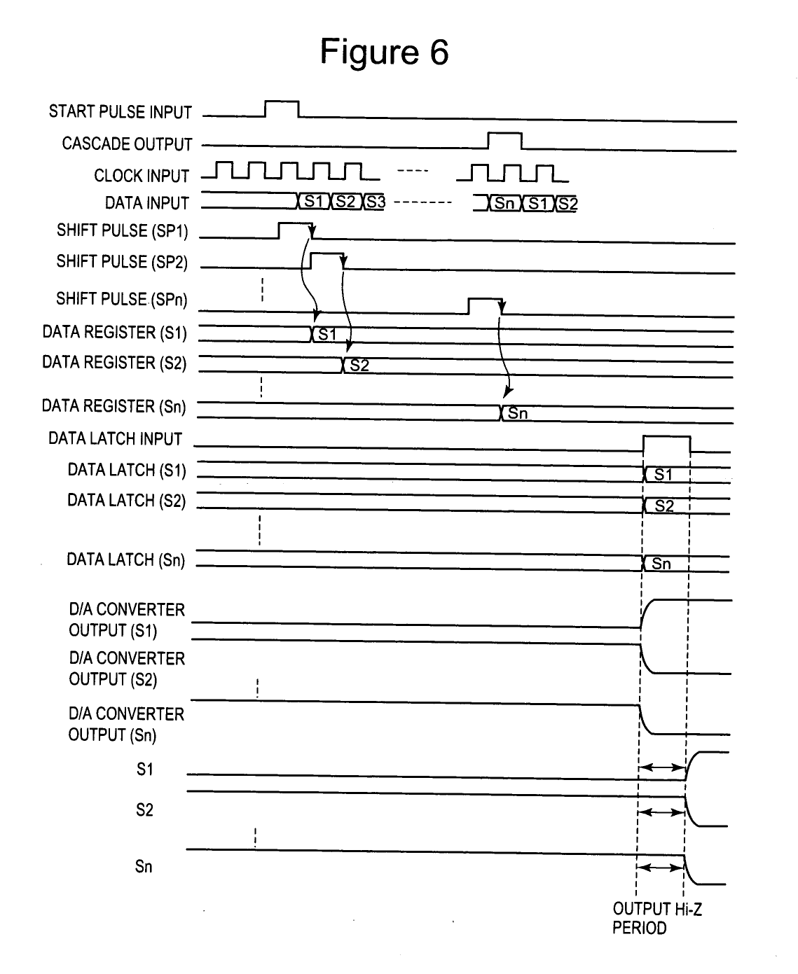

A description will be given as to a test method of leakage current fault detection on an output side of the output circuit 11 of the driver circuit 10 having the above configuration. FIG. 3 is a diagram showing a test apparatus of the driver circuit according to this embodiment. As shown in FIG. 3, the test apparatus is includes LSI testers 20a and 20b.

The LSI tester 20a is connected to the switch circuit 12. The LSI tester 20a is a pattern generator, which generates a test signal TEST and supplies it to the switch circuit 12.

The LSI tester 20b is connected to output terminals S1 to Sn. The LSI tester 20b is a DC test unit, which includes n pieces of DC relay switch 21₁ to 21ₙ and n pieces of voltage generation current measurement circuit (VSIM) 22₁ to 22ₙ correspondingly to the output terminals S1 to Sn. The output terminals S1 to Sn can be connected with the voltage generation current measurement circuits (VSIM) 22₁ to 22ₙ by each of the DC relay switches 21₁ to 21ₙ so as to generate voltage and measure currents with the voltage generation current measurement circuits (VSIM) 22₁ to 22ₙ.

The switch circuit 12 is set in the test mode by inputting the test signal TEST from the LSI tester 20a. If the test signal TEST in the test mode is at the “H” level, then the test signal TEST is directly inputted to the gate of the P-channels of the switches 12a and 12b and the gate of the N-channels of the switches 12c and 12d of the switch circuit 12 and inputted to the gate of the N-channels of the switches 12a and 12b and the gate of the P-channels of the switches 12c and 12d via an inverter INV 2.

In the test mode, the switches 12a and 12b are turned off and the switches 12c and 12d are turned on. Due to this operation of the switch circuit 12, the off switch 7b has the high power source potential VDD inputted to the gate of the P-channel and the low power source potential VSS inputted to the gate of the N-channel. Consequently, the off switch 7b is off-controlled, and high impedance arises between the output of each of the AMPs 7a and the output terminals S1 to Sn so that they are electrically separated.

In the above-mentioned test mode, the leakage current fault detection among the output terminals S1 to Sn of the driver circuit 10 is tested by the LSI testers 20a and 20b as follows. Within the LSI tester 20b, the output terminals S1 to Sn are connected with the voltage generation current measurement circuits (VSIM) 22₁ to 22ₙ by the DC relay switches 21₁ to 21ₙ. Predetermined test voltage higher than the low power source potential VSS is applied to odd-numbered output terminals S1, S3 to Sn-1 from the voltage generation current measurement circuits (VSIM) 22₁, 22₃ to 22ₙ₋₁. The test voltage of the low power source potential VSS is applied to even-numbered output terminals S2, S4 to Sn from the voltage generation current measurement circuits (VSIM) 22₂, 22₄ to 22ₙ. Or else, the predetermined test voltage higher than the low power source potential VSS can be applied to the even numbered output terminals S2, S4 to Sn from the voltage generation current measurement circuits (VSIM) 22₂, 22₄ to 22ₙ. The test voltage of the low power source potential VSS can be applied to the odd-numbered output terminals S1, S3 to Sn-1 from the voltage generation current measurement circuits (VSIM) 22₁, 22₃ to 22ₙ₋₁. Thus, it is possible to measure leakage currents among the output terminals S1 to Sn with ammeters included in the voltage generation current measurement circuits (VSIM) 22₁ to 22ₙ. In this case, the leakage current of the off switch 7b can also be detected.

As described above, the off switch 7b can be turned off upon inputting the test signal unlike the conventional case where the testing pattern is run until the data latch signal becomes the “H” level and stopped once in the “H” level state so as to turn off the off switch 7b. For this reason, test time of the leakage current fault detection can be rendered shorter than the conventional case.

Although the embodiments of the present invention have been described in various manners, it should not be interpreted that the present invention is restricted to the above-mentioned embodiments.

Further, it is noted that, Applicant's intent is to encompass equivalents of all claim elements, even if amended later during prosecution.

What is claimed is:

1. A drive circuit of a display unit including an output circuit, said output circuit comprising:
an amplifier which amplifies an analog signal voltage according to a digital image signal; and
a switch which turns off to isolate an output of the amplifier from an output terminal in response to a test signal.

2. The drive circuit of a display unit according to claim 1, wherein the output circuit includes a control circuit which controls the switch to turn off in response to a data latch signal during said test signal indicating a non-test mode, and controls the switch to turn off in response to a power source potential during said test signal indicating a test mode.

3. The drive circuit of a display unit according to claim 2, wherein said control circuit includes a transistor, which applies said data latch signal to the switch, and has a conductive state thereof controlled in response to said test signal.

4. A method of controlling a drive circuit of a display unit including an output circuit, said method comprising:
turning off a switch to electrically separate an amplifier from an output terminal, in response to a test signal independently of a data latch signal to detect a leakage current fault on an output of the output circuit.

5. The method as claimed in claim 4, further comprising turning off said switch in response to said data latch signal during said test signal indicating a non-test mode.

6. The method as claimed in claim 5, further comprising turning off a transistor for transferring said data latch signal to said switch, in response to said test signal.

7. The method as claimed in claim 4, wherein said output terminal includes a plurality of output terminals, said switch includes a plurality of switches provided for the respective output terminals, said method further comprises:
connecting a first test circuit to a first output terminal of said output terminals, to apply a first voltage to said first output terminal of said output terminals;
connecting a second test circuit to a second output terminal of said output terminals, to apply a second voltage to said second output terminal of said output terminals; and
detecting a current flowing between said first and second output terminals while turning off said switches in response to a test signal.

8. A drive circuit of a display unit, comprising:
a digital to analog converter which converts digital image data into a plurality of analog signals;
a plurality of amplifiers each of which amplifies the respective analog signal voltage;
a plurality of switch circuits coupled between said plurality of amplifiers and a plurality of output terminals, respectively; and
a control circuit which controls said switch circuits in response to a data latch circuit, and controls said switch circuits in response to a test signal independently of said data latch circuit.

9. The drive circuit as claimed in claim 8, wherein said control circuit receives a first power source voltage and a second power source voltage which are applied to said switch circuits in response to said test signal.

10. The drive circuit as claimed in claim 9, wherein said control circuit includes a transistor, which applies said data latch signal to the switch circuits, and has a conductive state driven thereof in response to said test signal.

11. A drive circuit of a display unit including an output circuit, said output circuit comprising:
means for amplifying an analog signal voltage according to a digital image signal; and
means for turning off to isolate an output of the amplifying means from an output terminal in response to a test signal.
